(19) United States
(12) Patent Application Publication
(10) Pub. No.: US 2007/0286498 A1
(43) Pub. Date: Dec. 13, 2007

(54) PATTERN DETECTING METHOD AND APPARATUS THEREOF

(76) Inventors: Po-Wei Chao, Taipei Hsien (TW); Hsin-Ying Ou, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/740,928

(22) Filed: Apr. 27, 2007

(30) Foreign Application Priority Data
May 10, 2006 (TW) 095116545

(51) Int. Cl. G06K 9/68; G06K 9/62

(52) U.S. Cl. 382/218; 382/209

(57) ABSTRACT

The invention discloses a pattern detecting apparatus. The pattern detecting apparatus includes a comparing module and a determining module. The comparing module compares a plurality of pixels of a pixel window in an image. The determining module determines whether the pixel window matches any predetermined pattern of a plurality of predetermined patterns according to results of comparing the pixels by the comparing module.

### BACKGROUND OF THE INVENTION

1. Field of the Invention

The invention relates to processing digital images, and more particularly, to a method and related apparatus capable of detecting predetermined patterns in digital images.

2. Description of the Prior Art

Edge detecting mechanisms and methods are often applied in processing digital images or digital videos. For example, when transforming an interlaced format to a progressive format (i.e. de-interlacing), performing noise reduction operations, or performing image enhancement operations, edge detecting mechanisms and methods will be utilized.

Sobel filters and Laplace filters are two kinds of filters utilized for edge detecting. Sobel filters 110, 120, 130, and 140 are four examples shown in FIG. 1. Sobel filters 110, 120, 130, and 140 determine whether a pixel corresponds to a horizontal edge, a vertical edge, a right tilted edge, or a left tilted edge. Generally, the Sobel filter can determine the edge directions correctly. However, the Sobel filter might not always determine what the edge direction is, and might even determine a wrong direction, resulting in errors in following image processing operations. For example, Sobel filters 150 and 160 shown in FIG. 1 are two examples of pixel windows not determined correctly. Taking the pixel window 150 shown in FIG. 1 as an example, the Sobel filter erroneously determines the pixel window 150 as a pixel window which does not correspond to the edge, whereas in fact, the pixel window 150 should be a pixel window corresponding to the right tilted edge. Taking the pixel window 160 shown in FIG. 1 as an example, the Sobel filter erroneously determines the pixel window 160 as a pixel window corresponding to the left tilted edge, whereas in fact, the pixel window 150 should be a pixel window corresponding to the right tilted edge.

### SUMMARY OF THE INVENTION

According to an embodiment of the present invention, a pattern detecting apparatus is disclosed. The pattern detecting apparatus includes: a comparing module, for comparing a plurality of pixels of a pixel window in an image; and a determining module for determining whether the pixel window matches any one of a plurality of predetermined patterns according to the comparing results generated by the comparing module.

According to an embodiment of the present invention, an edge detecting apparatus is further disclosed. The edge detecting apparatus includes: an edge detecting module, for determining whether a pixel in an image corresponds to an edge to generate an edge detecting result; a pattern detecting apparatus, for determining whether a pixel window in the image matches any one of a plurality of predetermined patterns to generate a pattern detecting result, wherein the pixel window corresponds to the pixel; and a detecting result integrating module, for generating a final edge detecting result according to the edge detecting result and the pattern detecting result.

According to an embodiment of the present invention, a pattern detecting method is further disclosed. The pattern detecting method includes: comparing a plurality of pixels of a pixel window in an image; and determining whether the pixel window matches any one of a plurality of predetermined patterns according to results of comparing the pixels.

According to an embodiment of the present invention, an edge detecting method is further disclosed. The edge detecting method includes: determining whether a pixel in an image corresponds to an edge to generate an edge detecting result; determining whether a pixel window in the image matches any one of a plurality of predetermined patterns to generate a pattern detecting result, wherein the pixel window corresponds to the pixel; and generating a final edge detecting result according to the edge detecting result and the pattern detecting result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows examples of conventional Sobel filters and illustrations of conventional Sobel filters identifying pixel windows incorrectly.

FIG. 2 is a pattern detecting apparatus according to an embodiment of the present invention.

FIGS. 3 and 4 show twelve examples of predetermined result combinations and predetermined patterns.

FIG. 5 is an edge detecting apparatus according to an embodiment of the present invention.

### DETAILED DESCRIPTION

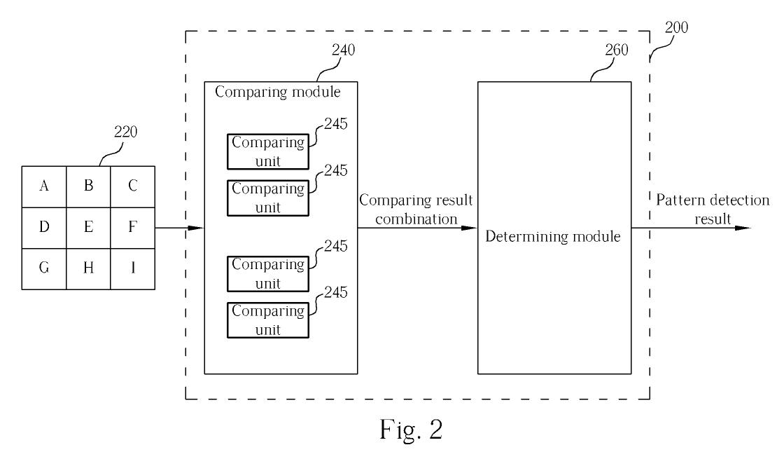

Please refer to FIG. 2. FIG. 2 is a pattern detecting apparatus 200 according to an embodiment of the present invention. The pattern detecting apparatus 200 includes a comparing module 240 and a determining module 260. The comparing module 240 is utilized for comparing a plurality of pixels (including pixels A, B, C, D, E, F, G, H, and I) of a pixel window 220 in an image. The determining module 260 is utilized for determining whether the pixel window 220 matches any predetermined pattern of a plurality of predetermined patterns according to results of comparing the pixels utilizing the comparing module 240.

The comparing module 240 can include a plurality of comparing units 245, and each comparing unit 245 is utilized for determining whether a difference between two pixels of the pixel window 220 is larger than a predetermined threshold value TH. For example, a comparing unit 245 determines whether a difference abs (A-D) between pixels A and D is larger than a predetermined threshold value TH, while another comparing unit 245 determines whether a difference abs (A-B) between pixels A and B is larger than a predetermined threshold value TH, and still another comparing unit 245 determines whether a difference abs (A-E) between pixels A and E is larger than a predetermined threshold value TH, etc. Please note that “each comparing unit 245 uses the same predetermined threshold value” is only an example. “Different comparing units 245 use different predetermined threshold values” is also practicable. Other comparing methods with the same spirit all fall within the scope of the present invention.

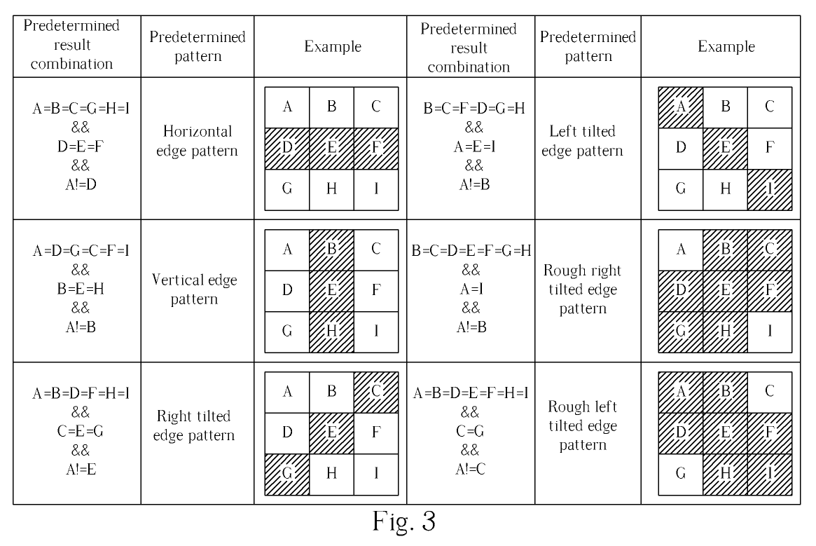

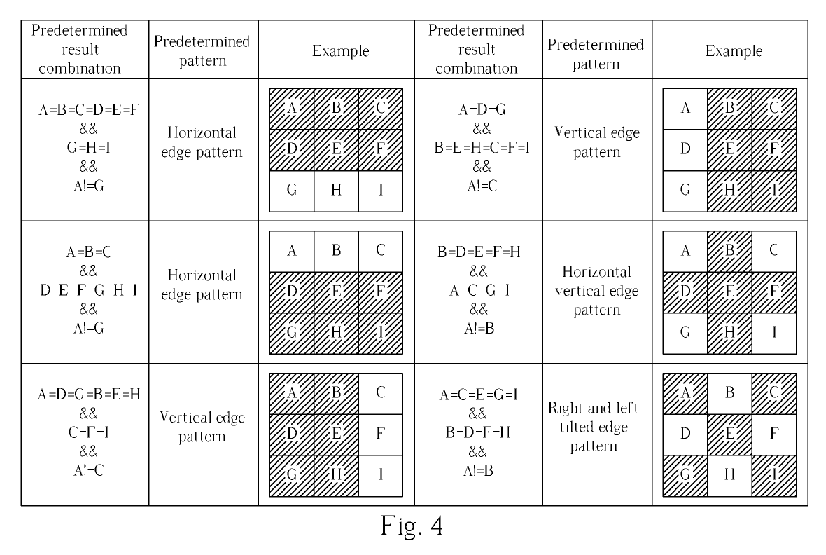

A comparing result combination is generated according to a plurality of comparing results generated by the comparing units 245. The determining module 260 determines whether the comparing result combination is similar to any predetermined result combination of a plurality of predetermined result combinations in order to determine whether the pixel window 220 matches any predetermined pattern of the predetermined patterns. In this embodiment, the predetermined result combinations correspond to the predetermined patterns respectively. FIGS. 3 and 4 show twelve examples of predetermined result combinations and predetermined patterns. If the comparing result combination matches a predetermined result combination of “A=B=C=G=H=I && D=E=F && A!=D”, the determining module 260 determines the pixel window 220 matches a predetermined pattern of “horizontal edge pattern”. If the comparing result combination matches a predetermined result combination of “A=B=D=F=H=I && C=E=G && A!=E”, the determining module 260 determines the pixel window 220 matches a predetermined pattern of “right tilted edge pattern”. Please note that if the comparing result combination is similar to the predetermined result combination of “A=B=C=G=H=I && D=E=F && A!=D”, the determining module 260 will still determine the pixel window 220 matches a predetermined pattern of “horizontal edge pattern”. Similarly, if the comparing result combination is similar to the predetermined result combination of “A=B=D=F=H=I && C=E=G && A!=E”, the determining module 260 will still determine the pixel window 220 matches a predetermined pattern of “right tilted edge pattern”.

Although each predetermined pattern in the twelve examples shown in FIGS. 3 and 4 is a predetermined pattern of “edge pattern”, when defining the predetermined result combinations and the predetermined patterns, other predetermined result combinations and other predetermined patterns (which are not necessary to be corresponding to “edge”) can also be defined according to the system operation requirements to provide a pattern detecting function more completely.

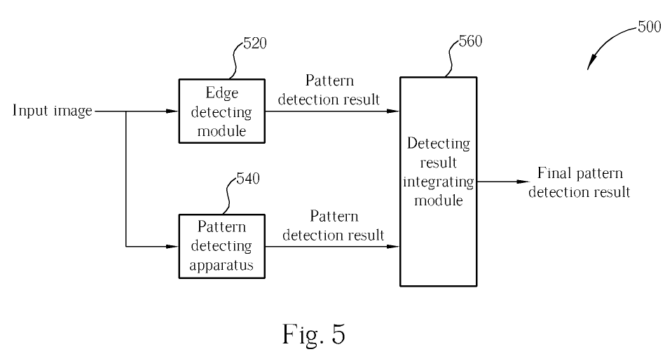

Additionally, the pattern detecting apparatus of the present invention can be utilized with a conventional edge detecting module to compensate for the deficiencies of the conventional edge detecting module. FIG. 5 is an edge detecting apparatus according to an embodiment of the present invention. The edge detecting apparatus 500 of the embodiment includes an edge detecting module 520, a pattern detecting apparatus 540, and a detecting result integrating module 560. The edge detecting module 520 includes a conventional Sobel filter or Laplace filter, which determines whether a pixel in an input image corresponds to an edge via a conventional method. The pattern detecting apparatus 540 have the same configuration with the pattern detecting apparatus 200 shown in FIG. 2, and the pattern detecting apparatus 540 is utilized for detecting whether a pixel window in the input image matches or is similar to any predetermined pattern of a plurality of predetermined patterns to generate a pattern detecting result. The detecting result integrating module 560 is utilized for generating a final edge detecting result according to the edge detecting result and the pattern detecting result. Since the pattern detecting apparatus 540 is utilized to compensate for the deficiencies of the conventional edge detecting module 520, the edge detecting apparatus 500 of the embodiment are capable of detecting edge more accurately.

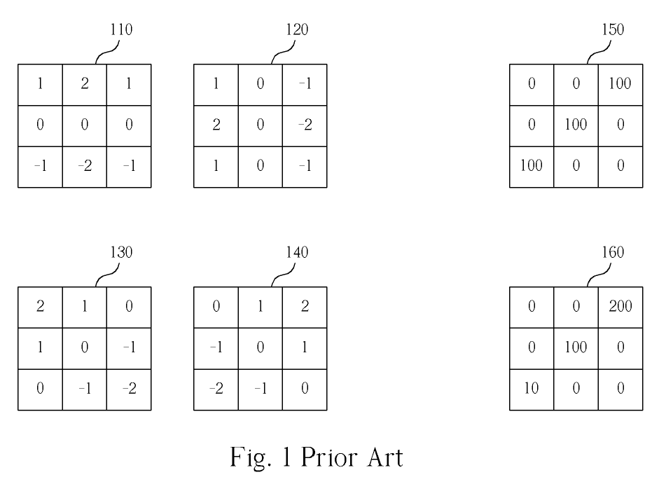

Various practicable methods for the operation of the detecting result integrating module 560 are provided. For example, the detecting result integrating module 560 can take the edge detecting results as a principal result, and take the pattern detecting results as an auxiliary result to output the final edge detecting result. The detecting result integrating module 560 can also take the pattern detecting results as the principal result, and take the edge detecting results as the auxiliary result to output the final edge detecting result. Taking the pixel window 150 shown in FIG. 1 as an example, the edge detecting results and the pattern detecting results outputted by the edge detecting module 520 and the pattern detecting apparatus 540 are a “non edge pattern” and “right tilted edge pattern” respectively, and the detecting result integrating module 560 can utilize the “right tilted edge pattern” as the final edge detecting result at this time. Taking the pixel window 160 shown in FIG. 1 as an example, the edge detecting results outputted by the edge detecting module 520 and the pattern detecting results outputted by the pattern detecting apparatus 540 are a “left tilted edge pattern” and a “right tilted edge pattern” respectively, and the detecting result integrating module 560 can utilize the “right tilted edge pattern” as the final edge detecting result at this time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A pattern detecting apparatus, comprising:
a comparing module, for comparing pixel values of a plurality of pixels of a pixel window in an image; and
a determining module, for determining whether the pixel window matches any one of a plurality of predetermined patterns according to the comparing results generated by the comparing module.

2. The pattern detecting apparatus of claim 1, wherein the comparing module comprises a plurality of comparing units, each comparing unit utilized for determining whether a difference between pixel values of two pixels of the pixel window is larger than a predetermined threshold value.

3. The pattern detecting apparatus of claim 1, wherein the comparing module compares the pixel values of the plurality of pixels to generate a comparing result combination.

4. The pattern detecting apparatus of claim 3, wherein the determining module determines whether the comparing result combination is similar to any one of a plurality of predetermined result combinations to determine whether the pixel window matches any one of the predetermined patterns.

5. The pattern detecting apparatus of claim 4, wherein the predetermined result combinations correspond to the predetermined patterns respectively.

6. The pattern detecting apparatus of claim 1, wherein the predetermined patterns comprise a plurality of edge patterns.

7. An edge detecting apparatus, comprising:
an edge detecting module, for determining whether a pixel in an image corresponds to an edge to generate an edge detecting result;
a pattern detecting module, for determining whether a pixel window in the image matches any one of a plurality of predetermined patterns to generate a pattern detecting result, wherein the pixel window corresponds to the pixel; and
a detecting result integrating module, for generating a final edge detecting result according to the edge detecting result and the pattern detecting result.

8. The edge detecting apparatus of claim 7, wherein the pattern detecting module comprises:
a comparing module, for comparing a plurality of pixels of the pixel window; and
a determining module, for determining whether the pixel window matches any one of a plurality of predetermined patterns according to the comparing results generated by the comparing module, to generate the pattern detecting result.

9. The edge detecting apparatus of claim 8, wherein the comparing module comprises a plurality of comparing units, each comparing unit utilized for determining whether a difference between pixel values of two pixels of the pixel window is larger than a predetermined threshold value.

10. The edge detecting apparatus of claim 8, wherein the comparing module compares the plurality of pixels to generate a comparing result combination, and the determining module determines whether the comparing result combination is similar to any one of a plurality of predetermined result combinations to determine whether the pixel window matches any one of the predetermined patterns, wherein the predetermined result combinations correspond to the predetermined patterns respectively.

11. The edge detecting apparatus of claim 7, wherein the predetermined patterns comprise a plurality of edge patterns.

12. A pattern detecting method, comprising:
comparing a plurality of pixel values of pixels of a pixel window in an image; and
determining whether the pixel window matches any one of a plurality of predetermined patterns according to the comparing results.

13. The pattern detecting method of claim 12, wherein the comparing step comprises:
generating a comparing result combination.

14. The pattern detecting method of claim 13, wherein the determining step comprises:
determining whether the comparing result combination is similar to any one of a plurality of predetermined result combinations;
wherein the predetermined result combinations correspond to the predetermined patterns respectively.

15. The pattern detecting method of claim 12, wherein the predetermined patterns comprise a plurality of edge patterns.

16. An edge detecting method, comprising:
determining whether a pixel in an image corresponds to an edge to generate an edge detecting result;
determining whether a pixel window in the image matches any one of a plurality of predetermined patterns to generate a pattern detecting result, wherein the pixel window corresponds to the pixel; and
generating a final edge detecting result according to the edge detecting result and the pattern detecting result.

17. The edge detecting method of claim 16, wherein the step of determining whether the pixel window matches any one of the predetermined patterns comprises:
comparing a plurality of pixels of the pixel window; and
determining whether the pixel window matches any one of the predetermined patterns according to results of comparing the pixels.

18. The edge detecting method of claim 17, wherein the step of comparing the pixels comprises:
generating a comparing result combination.

19. The edge detecting method of claim 18, wherein the step of determining whether the pixel window matches any one of the predetermined patterns according to the results of comparing the pixels comprises:
determining whether the comparing result combination is similar to any one of a plurality of predetermined result combinations;
wherein the predetermined result combinations correspond to the predetermined patterns respectively.

20. The edge detecting method of claim 16, wherein the predetermined patterns comprise a plurality of edge patterns.
